(19) United States
(12) Patent Application Publication
(10) Pub. No.: US 2008/0036365 A1
(43) Pub. Date: Feb. 14, 2008

(54) Carbazole Derivative Containing Fluorene Group and Organic Electroluminescent Element

(75) Inventors: Tetsuzo Miki, Ibaraki (JP); Yoshio Taniguchi, Nagano (JP); Musubu Ichikawa, Nagano (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Hodogaya Chemical Co., Ltd., Kawasaki-shi (JP); Shinshu University, Nagano (JP)

(21) Appl. No.: 10/594,273

(22) PCT Filed: Mar. 25, 2005
(86) PCT No.: PCT/JP05/06417

§ 371 Date: Jul. 24, 2007

(30) Foreign Application Priority Data
Mar. 26, 2004 (JP) 2004-091550
Mar. 26, 2004 (JP) 2004-092362

(51) Int. Cl. C08K 3/00; H01J 1/63

(52) U.S. Cl. 313/504; 548/427

(57) ABSTRACT

The present invention provides a carbozole derivative containing a fluorene group, represented by the following general formula (1) and an organic electroluminescence device containing the compound: 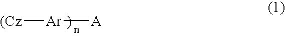 wherein Cz represents a substituted or unsubstituted carbazole group; Ar represents a substituted or unsubstituted aromatic hydrocarbon group, a substituted or unsubstituted aromatic heterocyclic group, or a substituted or unsubstituted condensation polycyclic aromatic group; A represents a substituted or unsubstituted fluorene group; and n is an integer of from 1 to 4. According to the present invention, a compound stable in thin film state and suitable as a host compound for an emission layer of an organic electroluminescence device or as a hole transporting material can be provided. By producing an organic electroluminescence device using the compound, emission efficiency and durability of the conventional organic electroluminescence device can be remarkably improved.

### TECHNICAL FIELD

The present invention relates to a compound and a device, suitable for an organic electroluminescence device which is a self-luminescent device suitable for various display devices, and particularly the invention relates to a carbazole derivative containing a fluorene group, and an organic electroluminescence device using the compound.

### BACKGROUND ART

Because an organic electroluminescence device is a self-luminescent device, it is luminous, excellent in visibility, and capable of giving clear display, as compared with a liquid crystal device. Therefore, active investigations have been made.

C. W. Tang et al. of Eastman Kodak Company developed a two-layer type laminated structure element in 1987, and this enabled an organic electroluminescence device using an organic substance to be put into practical use. They laminated an electron transporting fluorescent substance and a hole transporting organic substance, and injected both charges in a layer of the fluorescent substance to make the layer emit, thereby making it possible to attain high luminance of 1,000 cd/m² or more became at a voltage of 10V or lower (for example, see Patent Document 1 and Patent Document 2).

Patent Document 1: JP-A-8-48656

Patent Document 2: Japanese Patent No. 3194657

Recently, as an approach to increase emission efficiency of a device, a device that generates phosphorescence using a phosphorescence-emitting substance, that is, utilizing fluorescence from a triplet-excited state, is under development. According to the theory of an excited state, in the case of using phosphorescence, theoretically the efficiency of about 4 times the conventional fluorescence becomes possible, and remarkable increase in emission efficiency is expected.

Although a fluorescent substance can be singly used as a fluorescent layer, since a phosphorescent substance induces concentration quenching, it is therefore supported by doping a charge transporting compound generally called a host compound therewith. As the host compound, 4,4′-di(N-carbazolyl)biphenyl (hereinafter referred to as CBP) represented by the following formula was widely used (for example, see Non-Patent Document 1).

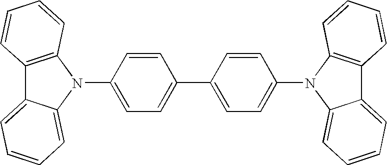

Non-Patent Document 1: Appl. Phys. Let., 75. 4 (1999)

However, CBP has high crystallinity such that a glass transition temperature is not observed by DSC analysis, and it was therefore pointed out to be poor in stability in a thin film state. For this reason, satisfactory device characteristics were not obtained in the case of requiring heat resistance, such as high luminance emission of an organic electroluminescence device.

To improve device characteristics of an organic electroluminescence device, an organic compound having excellent characteristics as a host compound, and high stability in a thin film state is demanded.

### DISCLOSURE OF THE INVENTION

### Problems that the Invention is to Solve

An object of the present invention is to provide a compound having excellent characteristics as a host compound, and high stability in a thin film state.

Another object of the present invention is to provide an organic electroluminescence device of high luminance, high efficiency and high durability using the compound.

As physical characteristics of the compound suitable to the present invention, there can be exemplified that (1) it is stable in a thin film state, (2) it has appropriate HOMO and LUMO levels, and (3) it has an excited triplet level of energy higher than a phosphorescent substance. Further, as physical characteristics of the device suitable to the present invention, there can be exemplified that (1) its emission efficiency is high, and (2) its durability is excellent.

### Means for Solving the Problems

To achieve the above objects, the present inventors have designed and chemically synthesized novel compounds which are various carbazole derivatives, experimentally produced various organic electroluminescence devices using the compounds, and closely investigated characteristic evaluation of devices, thereby leading to completion of the present invention.

That is, the above objects of the present invention have been achieved by providing a carbazole derivative containing a fluorene group, represented by the general formula (I), and an organic electroluminescence device comprising a pair of electrodes and at least one organic layer interposed therebetween, wherein the compound is contained as a constituent material of at least one organic layer: 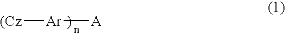
wherein Cz represents a substituted or unsubstituted carbazole group; Ar represents a substituted or unsubstituted aromatic hydrocarbon group, a substituted or unsubstituted aromatic heterocyclic group, or a substituted or unsubstituted condensation polycyclic aromatic group; A represents a substituted or unsubstituted fluorene group; and n is an integer of from 1 to 4.

The substituted or unsubstituted aromatic hydrocarbon group, substituted or unsubstituted aromatic heterocyclic group, and substituted or unsubstituted condensation polycyclic aromatic group, represented by Ar in the general formula (I), specifically include a phenyl group, a biphenylyl group, a terphenylyl group, a tetrakisphenyl group, a styryl group, a naphthyl group, an anthryl group, an acenaphthenyl group, a fluorenyl group, a phenanthryl group, an indenyl group, a pyrenyl group, a pyridyl group, a pyrimidyl group, a furanyl group, a pyronyl group, a thiophenyl group, a quinolyl group, a benzofuranyl group, a benzothiophenyl group, indolyl group, a carbazolyl group, a benzoxazolyl group, quinoxalyl group, a benzimidazolyl group, a pyrazolyl group, a dibenzofuranyl group, a dibenzothiophenyl group, and the like.

As the substituent in the substituted or unsubstituted aromatic hydrocarbon group, substituted or unsubstituted aromatic heterocyclic group, and substituted or unsubstituted condensation polycyclic aromatic group, represented by Ar in the general formula (I), specifically there are exemplified a fluorine atom, a chlorine atom, a cyano group, a hydroxyl group, a nitro group, an alkyl group, an alkoxy group, an amino group, a substituted amino group, a trifluoromethyl group, a phenyl group, a tolyl group, a naphthyl group, an aralkyl group and the like.

The substitution position on the substituent A of the carbazole derivative containing a fluorene group, represented by the general formula (I), 9-position of the fluorene group is preferred.

Further, in the present invention, the carbazole derivative containing a fluorene group, represented by the general formula (I) is preferably used as a constituent material of the emission layer of the organic electroluminescence device. By using as a host material for a fluorescent substance or a phosphorescent substance of the organic electroluminescence device, it gives an effect of improving characteristics of the device.

To increase durability of the organic electroluminescence device, it is considered to be good to use a compound having good thin film stability. Compounds having higher amorphous property give higher thin film stability, and a glass transition point (Tg) is used as a measure of the amorphous property (for example, see Non-Patent Document 4).

Non-Patent Document 4: “M & BE Association”, Vol. 11, No. 1, pages 34-41, (2000), The Japan Society of Applied Physics.

It is considered that higher glass transition point (Tg) is better. The carbazole derivative containing a fluorene group of the present invention has a glass transition exceeding 150° C., and thus the amorphous property is extremely high.

Additionally, the carbazole derivative containing a fluorene group of the present invention has not only high amorphous property and thin film state stability, but has an energy level suitable as a host material. Therefore, an organic electroluminescence device having high luminance and high durability can be realized.

### ADVANTAGE OF THE INVENTION

The carbazole derivative containing a fluorene group of the present invention is useful as a host compound for an emission layer of the organic electroluminescence device, or as a hole transporting material, can provide an organic electroluminescence device having high luminance and high durability by preparing an organic electroluminescence device using the compound, and can remarkably improve the performance of the conventional organic electroluminescence device.

### BRIEF DESCRIPTION OF THE DRAWINGS

FIG. 1 is a view showing a structure of the electroluminescence device of Example 6.

FIG. 2 is a graph comparing the current density/luminance characteristics between Example 6 and Comparative Example 1.

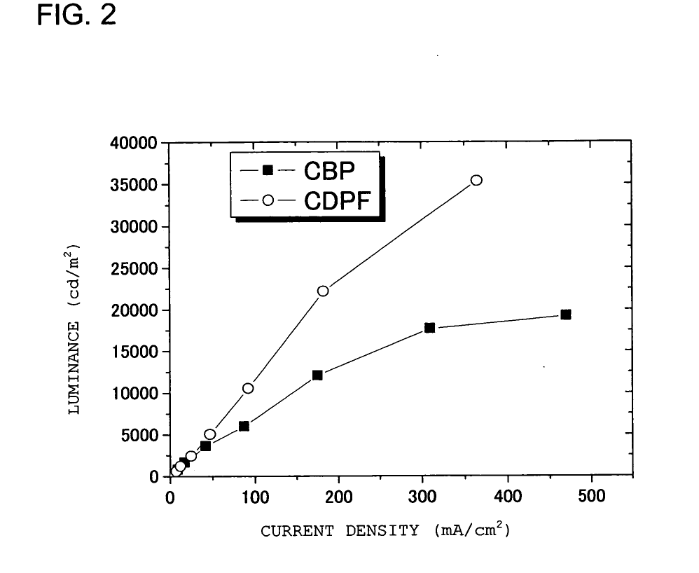

FIG. 3 is a graph comparing the current density/current efficiency between Example 6 and Comparative Example 1.

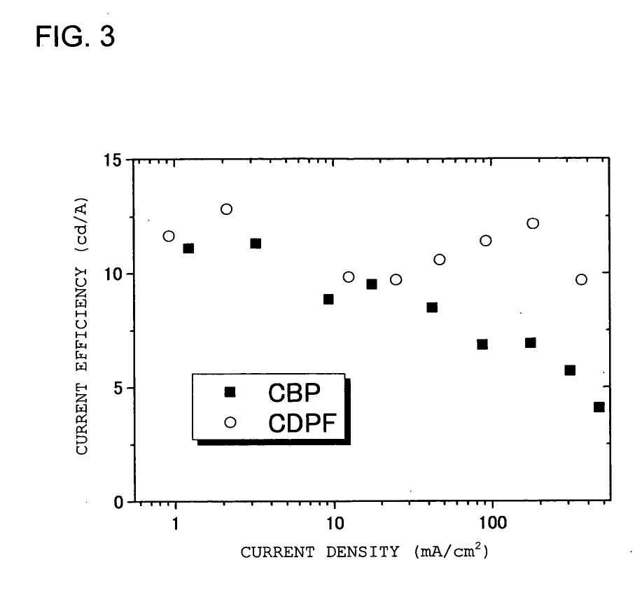

The reference numerals and symbols in the drawings show denote the followings.
1: Glass substrate
2: Transparent anode
3: Hole transporting layer
4: Emission layer
5: Hole blocking and electron transporting layer
6: Electron injecting layer
7: Cathode

### BEST MODE FOR CARRYING OUT THE INVENTION

The carbazole derivative containing a fluorene group of the present invention is a novel compound. Those compounds can be synthesized by condensing an arylamine and an aryl halide through Ullmann reaction.

Of the carbazole derivative containing a fluorene group, represented by the general formula (1), specific examples of the preferred compounds are shown below, but the invention is not limited to those compounds.

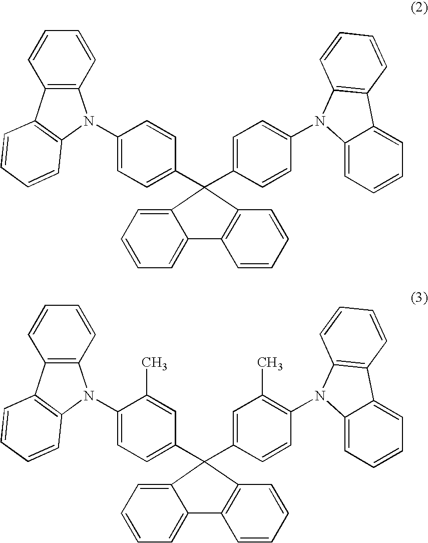

Purification of the compound of the present invention can be conducted by purification with column chromatography, recrystallization or crystallization with a solvent, and the like.

Identification of the compound of the present invention can be conducted by NMR analysis and elemental analysis. As a physical property value, a glass transition point (Tg) serving as a measure of stability in a thin film state was measured. The glass transition point was measured using a powder with a differential scanning calorimeter, a product of MacScience.

Further, work function was measured by preparing a 100 nm thin film on an ITO substrate and using an atmospheric photoelectron spectrometer AC2, a product of Riken Keiki Co., Ltd. The work function serves as a measure of hole blocking ability.

Similarly, a 100 nm thin film was prepared on a quartz substrate, an absorption spectrum was obtained using an ultraviolet-visible absorption analyzer UV 3150, a product of Shimadzu Corporation, and a band gap was obtained from a long-wave end.

The structure of the organic electroluminescence device of the present invention includes a structure comprising, successively on a substrate, an anode, a hole injecting layer, a hole transporting layer, an emission layer, a hole blocking layer, an electron transporting layer, an electron injecting layer and a cathode, or a structure comprising, successively on a substrate, an anode, a hole transporting layer, an emission layer, a layer serving as both hole blocking layer and electron transporting layer, an electron injecting layer and a cathode. Further, in those multilayered structures, several organic layers can be used in combination or can be omitted.

As the anode of the present invention, an electrode material having large work function, such as ITO or gold, is used. As the hole injecting layer, as well as copper phthalocyanine, materials or coating type materials, such as naphthalene diamine derivatives, starburst type triphenyl amine derivatives and naphthalene amine compounds, can be used. As the hole transporting layer of the present invention, as well as the carbazole derivative containing a fluorene group, benzidine derivatives such as N,N′-diphenyl-N,N′-di(m-tolyl)benzidine (hereinafter referred to as TPD) and N,N′-diphenyl-N,N′-di(α-naphthyl)benzidine (hereinafter referred to as NPD), various triphenyl amine tetramers, and the like can be used.

The emission layer of the present invention is prepared by generally doping a hole injecting and transporting host material with a fluorescent substance or a phosphorescent substance, called a dopant. In the organic electroluminescence device of the present invention, it is preferred to use the carbazole derivative containing a fluorene group, represented by the general formula (I), as a host material of the emission layer.

Further, the carbazole derivative containing a fluorene group, represented by the general formula (I), can be used singly, but can be used in a mixed state with CBP or the like by film formation through co-deposition or the like. In this case, the co-deposition has the effect of making CBP hard to crystallize.

The dopant for the emission layer of the present invention includes fluorescent substances such as quinacridone, coumarin 6 and rubrene, green phosphorescent substances such as iridium complex of phenyl pyridine (Ir(PPy)₃), blue phosphorescent substances such as FIrpic and Fir6, red phosphorescent substances such as Btp2Ir (acac), and the like.

The doping material, particularly the phosphorescent substance, induces concentration quenching, and therefore is preferably used for doping within the range of from 1 to 50% relative to the whole emission layer through co-deposition.

As the hole blocking layer of the present invention, compounds having low HOMO energy level, such as bathocuproine (hereinafter referred to as BCP), oxadiazole derivatives and aluminum (III) bis(2-methyl-8-quinolinate)-4-phenyl phenolate (hereafter referred to as BAlq), can be used.

As the electron transporting layer, oxadiazole derivatives, triazole derivatives, tris(8-hydroxyquinoline)aluminum which is an aluminum complex of quinoline (hereinafter referred to as Alq), BAlq and the like can be used. As the electron injecting layer of the present invention, there is, for example, lithium fluoride. However, in the preferred selection of the electron transporting layer and the cathode, this can be omitted. As the cathode, an electrode material having low work function, such as aluminum, and an alloy of magnesium and silver, can be used.

### EXAMPLES

The embodiments of the present invention are specifically illustrated below with reference to the Examples, but the invention is not limited to the following Examples so long as not exceeding its gist.

### Example 1

### Synthesis of 9,9-bis(4-carbazolylphenyl)fluorene (hereinafter referred to as CDPF) (2)

8.9 g of 9,9-bis(4-iodophenyl)fluorene, 5.5 g of carbazole, 4.8 g of potassium carbonate, 0.5 g of copper powder and 8 ml of diphenyl ether were heated at 240° C. under a nitrogen atmosphere to react for 4 hours. After completion of the reaction, 300 ml of toluene was added, followed by stirring for 1 hour. The mixture was heat filtered, and the filtrate was condensed to dryness to obtain a crude product. The dried crude product was purified by column chromatograph to obtain 3.7 g (yield 38%) of CDPF. The product was identified with NMR analysis. The results of ¹H-NMR analysis were as follows. 8.121 ppm (4H), 7.872 ppm (2H), 7.602 ppm (2H), 7.543-7.493 ppm (8H), 7.470-7.406 ppm (4H), 7.434 ppm (4H), 7.383 ppm (4H), 7.263 ppm (4H)

### Example 2

### Synthesis of 9,9-bis(4-carbazolyl-3-methylphenyl)fluorene (hereinafter referred to as CDMPF) (3)

4.6 g. of 9,9-bis(4-iodo-3-methylphenyl)fluorene, 2.8 g of carbazole, 2.5 g of potassium carbonate, 0.2 g of copper powder and 4 ml of n-dodecane were heated at 220° C. under a nitrogen atmosphere to react for 6 hours. After completion of the reaction, 200 ml of toluene was added, followed by stirring for 1 hour. The mixture was heat filtered, and the filtrate was condensed to dryness to obtain a crude product. The dried crude product was purified by column chromatograph to obtain 1.7 g (yield 38%) of CDMPF. The product was identified with NMR analysis. The results of ¹H-NMR analysis were as follows. 8.130 ppm (4H), 7.868 ppm (2H), 7.625 ppm (2H), 7.443 ppm (2H), 7.389 ppm (4H), 7.362 ppm (2H), 7.344 (4H), 7.285 ppm (4H), 7.233 ppm (2H), 7.060 ppm (4H), 1.883 ppm (6H). Further, the results (ppm) of ¹³C-NMR analysis were as follows. 150.538, 146.145, 140.945, 140.147, 136.946, 134.603, 130.693, 128.957, 127.896, 127.806, 127.197, 126.325, 125.707, 122.894, 120.351, 120.187, 119.442, 109.422, 65.218.

Further, the results of elemental analysis were as follows.

Theoretical value (carbon 90.5%, hydrogen 5.4%, nitrogen 4.1%)

Found value (carbon 90.2%, hydrogen 5.5%, nitrogen 4.0%)

### Example 3

A glass transition point was measured with a differential scanning calorimeter DSC (a product of MacScience) on CDPF (2), CDMPF (3) and CBP as a comparison. The measurement results were as shown below, and it was confirmed that the compound of the present invention has high glass transition point.

| | |
|---|---|
| CDPF | Glass transition point: 185° C. |
| CDMPF | Glass transition point: 164° C. |
| CBP | Glass transition point: Not observed |

### Example 4

A 100 nm thin film of CDPF (2), CDMPF (3) and CBP as a comparison was prepared on an ITO substrate, and work function was measured using an atmospheric photoelectron spectrometer AC2 (a product of Riken Keiki Co., Ltd). The measurement results were as follows.

| | |
|---|---|
| CDPF | Work function: 5.99 eV |
| CDMPF | Work function: 6.03 eV |
| CBP | Work function: 6.00 eV |

From the above results, it is seen that the compound of the present invention has an energy level suitable for transportation of a hole.

### Example 5

A 100 nm thin film of CDPF (2), CDMPF (3) and CBP as a comparison was prepared on a quartz substrate, an absorption spectrum was measured using an ultraviolet-visible absorption analyzer UV 3150 (a product of Shimadzu Corporation), and a band gap was calculated from a shortwave end. The band gap values were as follows.

| | |
|---|---|
| CDPF | Gap value: 3.50 eV |
| CDMPF | Gap value: 3.55 eV |
| CBP | Gap value: 3.44 eV |

From the above results, it can be considered that the compound of the present invention has a wide gap value as compared with CBP, and is suitable as a host compound for a dopant.

### Example 6

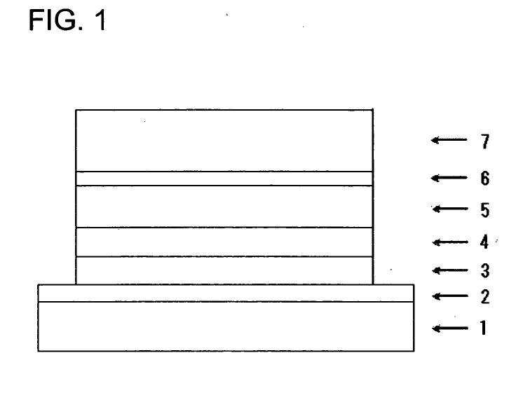

An organic electroluminescence device was prepared by successively depositing a hole transporting layer 3, an emission layer 4, a layer serving as both hole blocking layer and electron transporting layer 5, an electron injecting layer 6 and a cathode (aluminum electrode) 7, on an ITO electrode previously formed as a transparent anode 2 on a glass substrate 1, as shown in FIG. 1.

The glass substrate 1 having formed thereon a 150 nm thick ITO was washed with an organic solvent, and the surface was then washed with UV-ozone treatment. This was fitted in a vacuum deposition apparatus, and pressure was reduced to 0.001 Pa. Subsequently, as the hole transporting layer 3, TPD was formed to about 30 nm at a deposition rate of 0.6 Å/s.

Next, as the emission layer 4, CDPF (2) which is a host material was deposited at a deposition rate of 2 Å/s, and FIrpic which is a dopant was deposited at a deposition rate of 0.1 Å/s, by a dual simultaneous deposition method, to form the emission layer 4 containing 5% by weight of the dopant to about 40 nm. On the emission layer 4, BAlq as the layer serving as both hole blocking layer and electron transporting layer 5 was formed to about 30 nm at a deposition rate of 0.6 Å/s. The above depositions each were continuously conducted without breaking vacuum.

A mask for cathode deposition was inserted, and lithium fluoride was deposited on the layer serving as both hole blocking and electron transporting layer 5 to about 0.5 nm at a deposition rate of 0.1 Å/s to form the electron injecting layer 6. Finally, aluminum was deposited to 200 nm to form the cathode 7.

Characteristics of the organic electroluminescence device of the present invention thus formed were evaluated in terms of emission luminance and emission efficiency, defined by emission luminance/voltage, in the case of loading a current density of 300 mA/cm² at room temperature in the atmosphere. Further, as a measure value of durability of the organic electroluminescence device, the maximum luminance before breakthrough when increasing current density load was measured.

When current density of 300 mA/cm² was loaded to the organic electroluminescence device prepared, a stable blue emission was obtained at high luminance of 30500 cd/m². Emission efficiency at this luminance was as high as 10.3 cd/A. When the load was further increased, the maximum luminance reached 35500 cd/m², and then the device deteriorated.

### Comparative Example 1

For the sake of comparison, CBP was used as the host material of the emission layer 4 in place of CDPF (2), and the characteristics were examined. The device was prepared in the same manner as in Example 6.

When current density of 300 mA/cm² was loaded to the organic electroluminescence device using CBP, a blue emission 17300 cd/m² was obtained. Emission efficiency at this luminance was 5.8 cd/A. When load was further increased, the maximum luminance reached 19200 cd/m², and then the device deteriorated.

From the above results, it is apparent that emission efficiency and durability of the organic electroluminescence device of the present invention are superior to the conventional organic electroluminescence devices.

While the present invention has been described in detail and with reference to specific embodiments thereof, it will be apparent to one skilled in the art that various changes and modifications can be made therein without departing from the spirit and scope thereof.

This application is based on Japanese Patent Application No. 2004-091550 filed Mar. 26, 2004 and Japanese Patent Application No. 2004-092362 filed Mar. 26, 2004, the contents of which are herein incorporated by reference in their entities.

### INDUSTRIAL APPLICABILITY

The carbazole derivative containing a fluorene group of the present invention has high amorphous properties and is stable in a thin film state, and is therefore excellent as a compound for an organic electroluminescence device. Further, by preparing an organic electroluminescence device using the compound, emission efficiency and durability of the conventional organic electroluminescence device can remarkably be improved, and it became possible to spread the application, for example, to home appliances or illumination.

1. A carbozole derivative containing a fluorene group, represented by the following general formula (I): 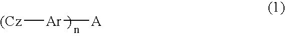
wherein Cz represents a substituted or unsubstituted carbazole group; Ar represents a substituted or unsubstituted aromatic hydrocarbon group, a substituted or unsubstituted aromatic heterocyclic group, or a substituted or unsubstituted condensation polycyclic aromatic group; A represents a substituted or unsubstituted fluorene group; and n is an integer of from 1 to 4.

2. An organic electroluminescence device comprising a pair of electrodes, and at least one organic layer interposed therebetween, wherein the device contains a carbozole derivative containing a fluorene group, represented by the following general formula (I) as a constituent material of the at least one organic layer: 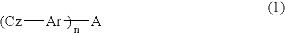
wherein Cz represents a substituted or unsubstituted carbazole group; Ar represents a substituted or unsubstituted aromatic hydrocarbon group, a substituted or unsubstituted aromatic heterocyclic group, or a substituted or unsubstituted condensation polycyclic aromatic group; A represents a substituted or unsubstituted fluorene group; and n is an integer of from 1 to 4.

3. The organic electroluminescence device as claimed in claim 2, containing the carbozole derivative containing a fluorene group, represented by the general formula (I) in an emission layer.

4. The organic electroluminescence device as claimed in claim 2 or 3, wherein emission from the device is mainly phosphorescence emission.
